(19) United States
(12) Patent Application Publication
(10) Pub. No.: US 2008/0107941 A1
(43) Pub. Date: May 8, 2008

(54) Method and apparatus for increasing a reliability of a fuel cell system

(76) Inventors: Dustan L. Skidmore, Latham, NY (US); Sriram Ganapathy, Rochester, NY (US); Daniel O. Jones, Glenville, NY (US); Manikandan Ramani, Watervliet, NY (US)

Correspondence Address: TROP PRUNER & HU, PC, 1616 S. VOSS ROAD, SUITE 750, HOUSTON, TX, 77057-2631, US

(21) Appl. No.: 11/645,245

(22) Filed: Dec. 22, 2006

Related U.S. Application Data
(60) Provisional application No. 60/856,687, filed on Nov. 3, 2006.

(51) Int. Cl. H01M 8/04

(52) U.S. Cl. 429/23

(57) ABSTRACT

A technique that is usable with a fuel cell stack includes detecting a negative cell voltage condition of the fuel cell stack and operating the fuel cell stack for an amount of time during which the negative cell voltage condition is present until the amount of time exceeds a first time threshold. The technique further includes determining the first time threshold based on the magnitude of the negative cell voltage.

This application claims the benefit under 35 U.S.C. § 119(e) to U.S. Provisional Patent Application Ser. No. 60/856,687, entitled, “METHOD FOR INCREASING THE RELIABILITY OF A FUEL CELL STACK,” which was filed on Nov. 3, 2006, and is hereby incorporated by reference in its entirety.

### BACKGROUND

The invention generally relates to fuel cell systems, and more particularly relates to a system and method for increasing the reliability of a fuel cell system.

A fuel cell is an electrochemical device that converts chemical energy directly into electrical energy. There are many different types of fuel cells, such as a solid oxide fuel cell (SOFC), a molten carbonate fuel cell, a phosphoric acid fuel cell, a methanol fuel cell and a proton exchange member (PEM) fuel cell.

As a more specific example, a PEM fuel cell includes a PEM membrane, which permits only protons to pass between an anode and a cathode of the fuel cell. A typical PEM fuel cell may employ polysulfonic-acid-based ionomers and operate in the 50° Celsius (C.) to 75° C. temperature range. Another type of PEM fuel cell may employ a phosphoric-acid-based polybenziamidazole (PBI) membrane that operates in the 150° C. to 200° C. temperature range.

At the anode of the PEM fuel cell, diatomic hydrogen (a fuel) is reacted to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:

H₂→2H⁺+2e⁻ at the anode of the cell, and Equation 1

O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

The fuel cell stack is one out of many components of a typical fuel cell system, which may include a cooling subsystem, a cell voltage monitoring subsystem, a control subsystem, a power conditioning subsystem, etc. A fuel cell system may be used in many different types of applications, such as a primary electrical power system for residential use or as a backup power system for a telecommunications system. Regardless the particular application, the reliability of the fuel cell system is of particular concern.

The overall reliability of the fuel cell system is affected by the reliability of each of its constituent subsystems, each of which may be prone to particular types of failures. For instance, the fuel cell stack is subject to several different types of failure modes. Many of these modes, such as membrane holes and destruction or thinning of the catalyst, may be caused by operating the fuel cell stack while one of more of the cells has a negative cell voltage. Typically, in the past, when the cell voltage monitoring subsystem detected the presence of a negative cell voltage, the control subsystem would automatically shut down the system and prevent further operation. However, in some instances, the automatic shutdown may have been initiated due to an erroneous indication of a negative cell voltage condition by the cell voltage monitoring subsystem. Thus, shutdown and prevention of further operation may have been unnecessary. In addition, preventing further operation may be an undesirable result, because troubleshooting the fuel cell system may be most efficiently accomplished while the system is operating. Still further, it may be possible to operate with a negative cell voltage for a limited number of hours without damaging the fuel cell stack. It would be desirable to take advantage of this additional operation time, particularly when the fuel cell system is used as a backup system, as the additional hours could translate into several additional months of operation.

### SUMMARY

In an embodiment of the invention, a technique that is usable with the fuel cell stack includes detecting a negative cell voltage condition of the fuel cell stack. The technique further includes operating the fuel cell stack for an amount of time during which the negative cell voltage condition is present until the amount of time exceeds a first time threshold.

In another embodiment of the invention, a technique usable with a fuel cell stack includes monitoring a cell voltage of the fuel cell stack while the fuel cell stack is operating and detecting presence of a negative cell voltage based on the monitored cell voltage. The technique further includes determining a magnitude of the negative cell voltage, determining an operation time limit based on the determined magnitude, and terminating operation of the fuel cell stack when a negative cell voltage operation time exceeds the determined operation time limit.

In yet another embodiment of the invention, a fuel cell system includes a fuel cell stack having a plurality of fuel cells, a cell voltage monitor to monitor a cell voltage of each of the plurality of fuel cells, and a controller to control operation of the fuel cell stack. The controller is configured to detect presence of a negative cell voltage based on the monitored cell voltages, operate the fuel cell stack for an amount of time during which the negative cell voltage is present, and terminate operation of the fuel cell stack when the amount of time exceeds a negative cell voltage time limit.

In another embodiment of the invention, an article comprises a computer readable storage medium that is accessible by a processor-based system. The article stores instructions that when executed by the processor-based system cause the processor-based system to detect a negative cell voltage condition of the fuel cell stack, operate the fuel stack for an amount of time during which the negative cell voltage condition is present, and terminate operation of the fuel cell stack when the amount of time exceeds a first time threshold.

Advantages and other features of the invention will become apparent from the following drawing, description and claims.

### BRIEF DESCRIPTION OF THE DRAWING

FIG. 1 is a schematic diagram of a fuel cell system according to an embodiment of the invention.

FIG. 2 is a graphical representation of data curves representing the maximum operating time limit at a particular magnitude of negative cell voltage for the fuel cell stack of the fuel cell system of FIG. 1.

FIG. 3 is a flow diagram depicting a technique to detect the presence of a negative voltage condition in a fuel cell stack of the fuel cell system of FIG. 1 according to an embodiment of the invention.

FIGS. 4A and 4B are a flow diagram depicting a technique to implement various alarm and shutdown procedures in response to detection of a negative voltage condition in a fuel cell stack of the fuel cell system of FIG. 1 according to an embodiment of the invention.

### DETAILED DESCRIPTION

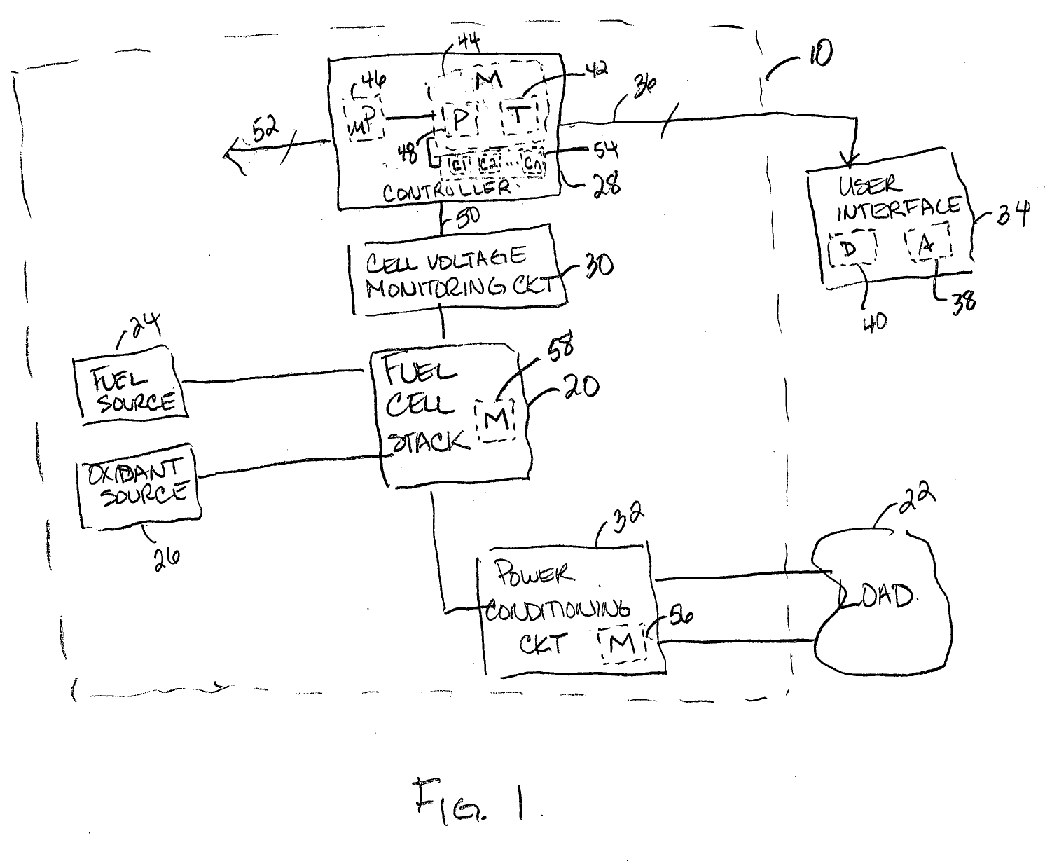

Referring to FIG. 1, an embodiment of a fuel cell system 10 in accordance with the invention includes a fuel stack 20 that is capable of producing power for a load 22 in response to fuel and oxidant flows that are provided by a fuel source 24 and an oxidant source 26, respectively. Fuel cell system 10 further includes a controller 28 that is generally configured to control the power produced by fuel stack 20 by controlling the fuel and oxidant flows provided by fuel source 24 and oxidant source 26. Typically, controller 28 bases (at least in part) its regulation of the fuel and oxidant flows on measured cell voltages of the fuel cell stack 20. The measured cell voltages are detected by a cell voltage monitoring circuit 30 that monitors the cell voltages of each of the fuel cells in the fuel cell stack 20. In general, the measured cell voltages are indicators of how efficiently the fuel cell system 10 is operating, as well as indicators of other operating conditions of fuel cell stack 20, as will be discussed in detail below.

In the embodiment illustrated in FIG. 1, fuel cell system 10 also includes a power conditioning circuit 32 that conditions the power produced by fuel stack 20 in an appropriate manner for the particular load 22. Information regarding the operating status and other operating parameters associated with fuel stack system 10 may be communicated by controller 28 to an attached user interface 34, such as via a bus 36. User interface 34 may include audible indicators 38 to provide audible warnings to an operator of system 10, a display or monitor 40 to provide messages, or other visible indicators (e.g., LEDs) to provide other visible information to the operator.

Fuel cell system 10 may be used in many different types of applications, including providing primary electrical power for residential use and backup power for telecommunication systems. Regardless of the type of application, the reliability of fuel system 10 is of particular concern. One factor that contributes to the reliability of fuel cell system 10 is the reliability of the fuel cell stack 20 itself. Should fuel cell stack 10 fail or provide an indication that causes a shutdown of system 10, system 10 will be incapable of producing power.

Many of the failure modes of fuel cell stack 20 may be caused by operating any one of the fuel cells at a negative voltage. Although operating at a negative cell voltage eventually will result in damage to the fuel cell stack 20, such as membrane holes and thinning or destruction of the catalyst, the damage does not occur immediately. In other words, it is possible to operate the fuel cell stack 20 for a limited period of time while the negative cell voltage condition is present. The maximum amount of negative cell voltage operating time is based, at least in part, on the magnitude of the negative cell voltage and the particular configuration of the fuel cell stack 20.

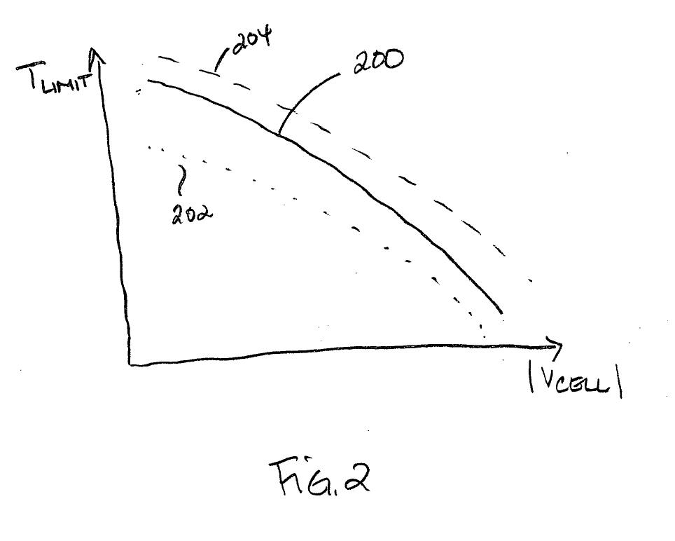

In one embodiment of the invention, a data curve 200, such as that illustrated in FIG. 2, may be developed which represents maximum operating time limits for different magnitudes of negative cell voltage. In addition to the voltage magnitude, other operating conditions may affect the maximum operating time, such as the size of the load that is powered by fuel system 10, temperature, etc. Thus, multiple data curves 200, 202, 204 may be developed, each of which provides an indication of the maximum operating time limit for various negative cell voltage magnitudes. Curves 200, 202, 204 may be determined based on empirical data or from a mathematical model of system 10. In one embodiment, once one or more curves 200 have been developed, data representing curves 200, 202, 204 may be stored in a table 42 in a memory, such as a nonvolatile memory 44 of controller 28.

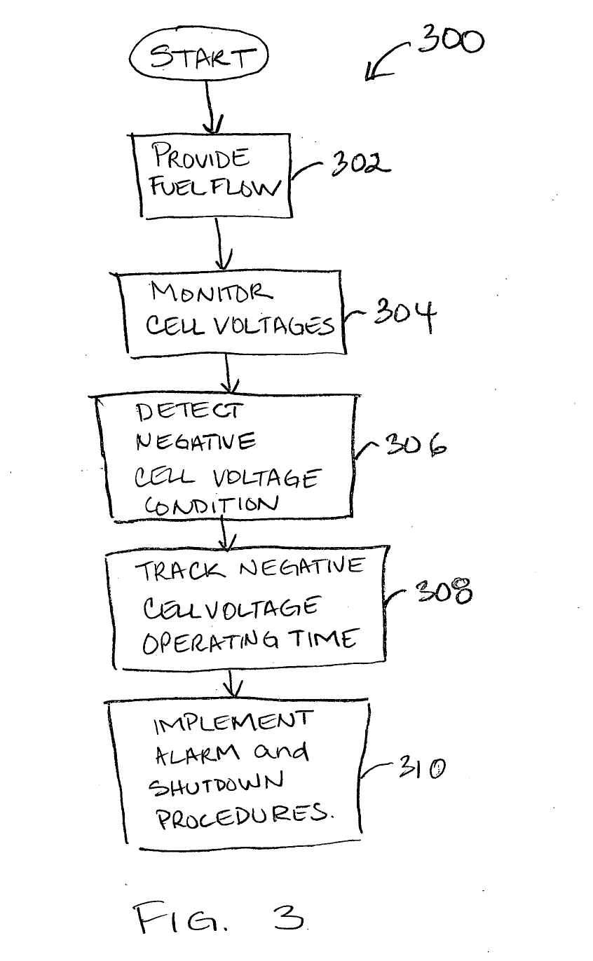

Referring now to FIG. 3, in accordance with some embodiments of the invention, controller 28 performs a technique 300 that using, in part, the data stored in table 42 that may result in increased reliability of fuel cell system 10. Controller 28 may perform technique 300 by using a processor 46 to execute program code 48 stored in memory 44 of controller 28. In accordance with one embodiment of technique 300, operation of fuel cell stack system 10 is initiated by providing a fuel flow to fuel cell stack 20 (block 302). While fuel cell system 10 is operating, cell voltage monitoring circuit 30 measures each of the cell voltages of stack 20 and communicates indications of the measured cell voltages to controller 28 via, for example, a serial bus 50 (block 304). In addition to measuring each of the individual cell voltages, cell voltage monitoring circuit 30 may be configured to measure the voltage across the entire fuel cell stack 20. An indication of the stack voltage also may be communicated to controller 28 via serial bus 50.

Based on the indications provided by cell voltage monitoring circuit 30, controller 28 may detect the presence of a negative cell voltage condition (block 306). For instance, a negative cell voltage condition may be detected if any one of the cell voltage indications provided by cell voltage monitoring circuit 30 falls below a predetermined threshold. In one embodiment, the predetermined threshold may be a magnitude of zero volts. In other embodiments, other cell voltage magnitudes may be selected, which may be either greater or less than zero volts.

In accordance with technique 300, system 10 may continue to operate while the negative cell voltage condition is present. When the negative cell voltage condition is first detected, tracking of the negative cell voltage operation time of fuel cell stack 20 is initiated and continues while the negative cell voltage condition is present (block 308). The tracked operation time may be continuous or, in applications in which fuel cell system 10 is stopped and started numerous times, the measured operation time may be accumulated over multiple operating periods of system 10.

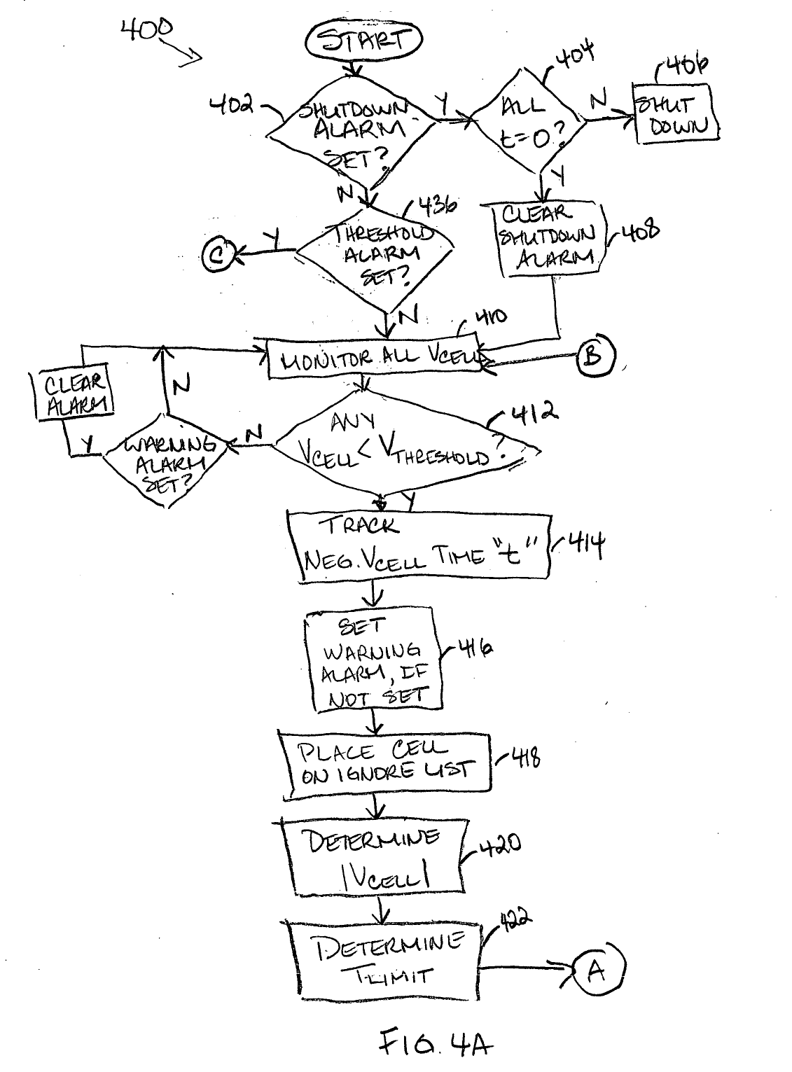

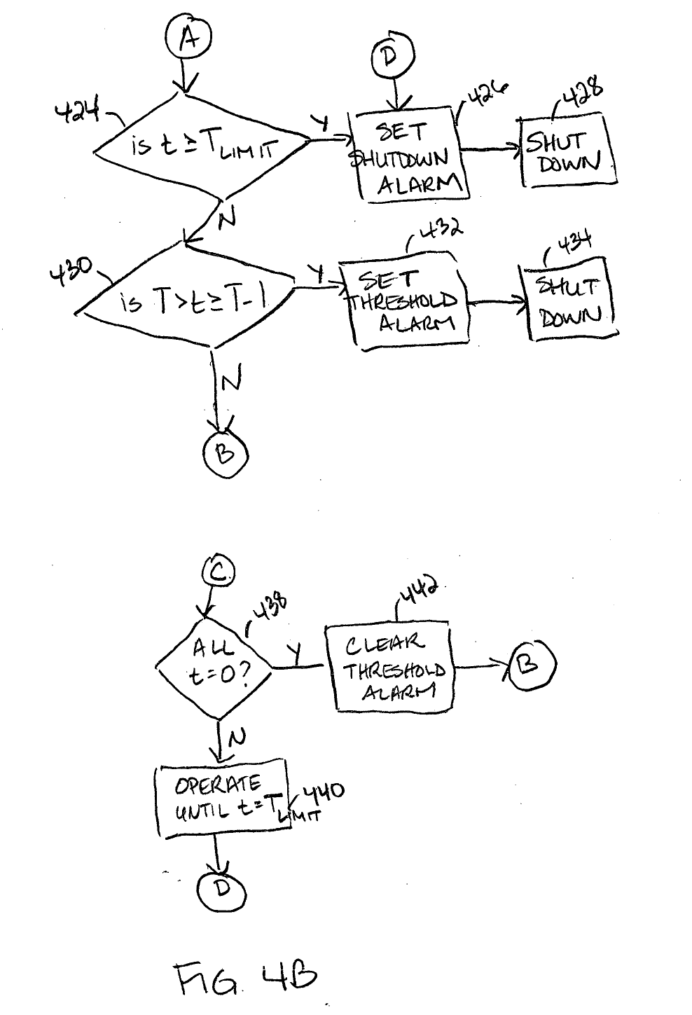

To reduce the risk of damage to fuel cell stack 20, fuel cell system 10 is not allowed to run indefinitely while a negative cell voltage condition is present. Thus, in accordance with technique 300, controller 28 implements various alarms and shutdown procedures (block 310) that may be based, at least in part, on the magnitude of the negative cell voltage and the duration of the negative cell voltage condition operating time. Examples of such alarms and shutdown procedures are provided in more detail in FIGS. 4A and 4B.

Turning now to FIGS. 4A and 4B, they show a possible embodiment of a technique 400 that may be executed by controller 28 to implement various alarm and shutdown procedures in response to detection of a negative cell voltage condition. For instance, upon initiation of the operation of fuel cell system 10, controller 28 may first determine whether the Shutdown Alarm has been set (diamond 402). If so, controller 28 may then determine whether a timer or counter 54 that tracks a cumulative negative cell voltage operating time has been set to zero (diamond 404). In one possible embodiment, timer 54 may be implemented as a plurality of counters (C₁, C₂, . . . C_{N}), each of which is associated with a particular fuel cell of fuel cell stack 20. When the fuel cell stack 20 is initially manufactured or installed in system 10, the counters may be set to an initial value. Upon detection of a negative cell voltage condition, the counter associated with the fuel cell identified as having a negative cell voltage is incremented. Thereafter, the counter associated with the affected fuel cell may continue to track the amount of time that the affected fuel cell operates with a negative cell voltage. In some instances, it is possible that the fuel cell may recover and the negative cell voltage condition will cease to exist. In such a situation, the counter associated with the fuel cell may not be reset such that a record of total negative cell voltage operating time can be maintained. In the event that the particular fuel cell again experiences a negative cell voltage, the timer or counter associated with that cell will again track the duration of the negative cell voltage operating time and will add this time to the previously accumulated amount.

In one embodiment of the invention, the indications of negative cell voltage operating time provided by each of the counters of timer 54 may be stored in a non-volatile memory, such as memory 44 in controller 28. The negative voltage operating times also may be stored in a second non-volatile memory, such as a memory 56 of power conditioning circuit 32. The negative cell voltage time indications may be stored in the second memory 56 as either an alternative or as a backup to the information stored in memory 44 of controller 28. In other embodiments, the negative cell voltage time indications may be stored in a non-volatile memory 58 that is part of the fuel cell stack 20 itself. Storing the time indications in a memory 58 included in the fuel stack 20 may be particularly advantageous as it may ensure that, in the event that fuel cell stack 20 is replaced, any negative cell operating time indications associated with that fuel cell stack automatically will be reset. Otherwise, in embodiments in which the negative cell voltage operating time is maintained in a memory that is not part of fuel cell stack 20, any stored time indications must be separately reset if the fuel cell stack 20 is replaced.

Returning again to FIG. 4, if controller 28 determines that the Shutdown Alarm indication is set and all of the negative operating time indicators are not set to an initial value (e.g., zero) then controller 28 will shutdown system 10 (block 406). System 10 may be shutdown, for instance, by providing control signals, such as via a bus 52, that terminate the fuel and oxidant flows provided by sources 24 and 26. As will be explained further below, Shutdown Alarm indication is representative of the situation in which a negative cell voltage operating time has reached or exceeded the maximum time limit, T_{LIMIT}. If controller 28 determines that all of the negative cell voltage operating time indicators have been set to an initial value, this is an indication that the fuel cell stack has been replaced and the associated counters have been reinitialized. In this case, controller 28 assumes that it is safe to permit operation of fuel cell system 10, clears the Shutdown Alarm (block 408), and proceeds with the normal routine of monitoring the cell voltage indications (block 410). Similarly, if, in block 402, controller 28 determines that the Shutdown Alarm has not been set, then controller 28 proceeds with monitoring the cell voltage indications (block 410).

In some embodiments, it may be desirable to provide several different levels of alarm indications, such as a Threshold Alarm indication, which will be discussed in detail below. In such embodiments, and as shown in FIGS. 4A and 4B, controller 28 may determine whether such other alarm indications have been set before proceeding to block 410.

Should controller 28 determine that any one of the monitored cell voltages is below a threshold (diamond 412), then the counter associated with the particular fuel cell will be incremented and an indication of cumulative negative cell voltage operating time will be stored in at least one of the non-volatile memories 44, 56 or 58 (block 414). If a negative cell voltage condition alarm has not been set, then controller 28 will set a Warning Alarm indication (block 416).

In one embodiment of the invention, the fuel cell that is associated with the negative cell voltage condition may be placed on an ignore list (block 418). Fuel cells that are placed on the ignore list are not considered when other control algorithms associated with fuel cell system 10 are implemented. Such other control algorithms may include, for instance, algorithms which control the fuel flow or oxygen flow provided to fuel cell stack 10. In the event that a fuel cell that has been placed on the ignore list does recover from the negative cell voltage condition, the fuel cell may be removed from the list and treated as a normal cell for purposes of the other control algorithms.

Returning again to FIGS. 4A and 4B, controller 28 may also determine the magnitude of the negative cell voltage experienced by the affected fuel cell (block 420). The magnitude of the negative cell voltage may be determined in various manners. In one possible embodiment, cell voltage monitoring circuit 30 may simply provide an indication that is a direct measurement of the magnitude of the negative cell voltage. In other possible embodiments, particularly in an embodiment in which cell voltage monitoring circuit is not configured to measure a negative voltage, an indication of approximately zero volts may be deemed to be representative of a negative cell voltage. In such a case, the magnitude of the negative cell voltage may be determined by summing all of the cell voltage indications of the individual fuel cells and then comparing the sum to the stack voltage indication. Thus, in one example of a negative cell voltage condition, for a fuel cell stack 20 having 63 fuel cells, each of which typically have a cell voltage of approximately one volt, the sum of the indications of cell voltage provided by the cell voltage monitoring circuit 30 may result in a total indication of 62 volts. However, the stack voltage indication provided by the cell voltage monitoring circuit 30 may represent a stack voltage of 61 volts. By comparing the summed indications with the stack voltage indication, it may be assumed that the magnitude of the negative voltage of the affected fuel cell is one volt. In the event that the indications of cell voltage provided by cell monitoring circuit 22 indicate that multiple fuel cells have a negative cell voltage, then, as a worse case scenario, it may be assumed that each of the identified negative voltage fuel cells has a negative cell voltage magnitude of one volt.

Returning again to FIGS. 4A and 4B, having determined the magnitude of the negative cell voltage, controller 28 may determine the appropriate negative cell voltage operating time limit, T_{LIMIT} (block 422). In one possible embodiment, the negative cell voltage operating time limit may be determined by retrieving the values stored in table 42 that are associated with the determined magnitude of the negative cell voltage.

If the time accumulated by the counter associated with the affected fuel cell reaches or exceeds T_{LIMIT} (diamond 424) then controller 28 may set an alarm (i.e., the Shutdown Alarm) that indicates that T_{LIMIT} has been exceeded (block 426) and then proceed to terminate operation of fuel cell system 10 (block 428). If T_{LIMIT} has not been exceeded, then controller 28 may determine whether a lesser time threshold has been reached (diamond 430). For instance, in some embodiments of the invention, it may be desirable to provide a forewarning that T_{LIMIT} is approaching. Such a warning may be useful to allow an operator of system 10 adequate time to perform troubleshooting procedures to identify the specific problem with system 10. In one embodiment, controller 28 provides the threshold warning when the cumulative amount of negative cell voltage operating time is within one hour of the negative voltage operating time limit, T_{LIMIT}. In the embodiment of technique 400 illustrated in FIGS. 4A and 4B, when controller 28 determines that the negative cell voltage operating time, t, is within one hour of T_{LIMIT}, controller 28 sets a Threshold Alarm (block 432) and then terminates operation of system 10 (block 434). When system 10 is restarted, and if it is determined that the Threshold Alarm has been set (diamond 436) and that the fuel cell stack 20 has not been replaced (i.e., all of the counters have not been set to an initial value) (diamond 438), then controller 28 will allow continued operation of system 10 until the negative cell voltage operating time reaches the time limit, T_{LIMIT} (block 440). At such time, controller 28 will set the Shutdown Alarm (block 426) and terminate operation of system 10 (block 428). As previously discussed, if the Shutdown Alarm has been set and the counters associated with the fuel cell have not been reset) (diamonds 402 and 404), further operation of the fuel cell system 10 is prohibited (block 406). If, however, at diamond 438, controller 28 determines that fuel cell stack 20 has been replaced, then controller 28 may clear the Threshold Alarm (block 442) and return to monitoring the cell voltages (block 410).

In some embodiments of the invention, it may be desirable to provide yet further time thresholds when various other alarms or warnings may be provided. For instance, although not shown in FIGS. 4A and 4B, if the Threshold Alarm level has not been reached, then controller 28 may determine whether the negative cell voltage operating time has reached another threshold, such as a threshold representing half of the operating time limit. If not, then controller 28 may simply return to block 410 where it continues to monitor the cell voltage indications. If the threshold has been reached, controller 28 may set another type of alarm indication and then return to block 410 where it continues to monitor the cell voltage indications.

In some embodiments of the invention, the various alarm indications set by controller 28 may be communicated to user interface 34 via bus 36 (see FIG. 1). User interface 34 may display various information including details of the type of alarm condition that has been indicated. For instance, user display 34 may display various warning messages such as “Negative Cell Life Exhausted—Replace Stack”, “Less than 1 Hour Stack Life Remaining”, or “Negative Cell Life Running Time Terminated”. In addition, user interface 34 may provide various audible alarms 38 to alert an operator of system 10 to the presence of an alarm condition.

Implementing the techniques illustrated in FIGS. 3, 4A and 4B may enhance the reliability of system 10 by providing the ability to run with negative cell voltages for a limited period of time. Reliability may be increased not only because of the increased operating time, but also because there may be failure modes which may result in negative cell voltage indications, but which do not necessarily hamper or prevent the system's ability to provide power to the load. For instance, it is possible that cell voltage monitoring circuit 30 may provide a false negative voltage indication. Rather than terminating operation of system 10 in response to the false indication, various warnings may be provided that provide time for an operator to discover the true source of the problem while allowing system 10 to continue to provide power to the load.

Many different embodiments of the invention, other than embodiments specifically described herein, are contemplated and are within the scope of the appended claims. For example, the fuel cell system 10 may use one of a variety of different fuel cell technologies. As non-limiting examples, the fuel cell stack 20 may include PEM-based fuel cells, alkaline-based fuel cells, phosphoric acid-based fuel cells, molten carbonate fuel cells or solid fuel oxide fuel cells (SOFCs). In addition, techniques 300 and 400 may be implemented in many different manners that may include fewer or additional steps or that may perform steps in different orders than described above. Thus, many variations are possible and are within the scope of the appended claims.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method usable with a fuel cell stack, comprising:
detecting a negative cell voltage condition of the fuel cell stack; and
operating the fuel cell stack for an amount of time during which the negative cell voltage condition is present until the amount of time exceeds a first time threshold.

2. The method as recited in claim 1, further comprising:
accumulating the amount of time during which the fuel cell stack is operating while the negative voltage condition is present; and
storing, in a nonvolatile memory, the accumulated amount of time.

3. The method as recited in claim 2, wherein the fuel cell stack includes the nonvolatile memory.

4. The method as recited in claim 1, wherein detecting the negative cell voltage condition comprises:
monitoring a cell voltage of the fuel cell stack; and
detecting presence of a negative cell voltage based on the monitored cell voltage.

5. The method as recited in claim 4, further comprising:
determining a magnitude of the negative cell voltage; and
determining the first time threshold based on the determined magnitude.

6. The method as recited in claim 5, further comprising:
preventing further operation of the fuel cell stack when the amount of time exceeds the first time threshold.

7. The method as recited in claim 6, further comprising:
interrupting operation of the fuel cell stack when the amount of time exceeds a second time threshold, wherein the second time threshold is less than the first time threshold.

8. The method as recited in claim 4, further comprising:
controlling operation of the fuel cell stack based in part on the monitored cell voltage; and
ignoring the monitored cell voltage when controlling operation of the fuel cell stack if the monitored cell voltage indicates presence of a negative cell voltage.

9. A method usable with a fuel cell stack, comprising:
monitoring a cell voltage of the fuel cell stack while the fuel cell stack is operating;
detecting presence of a negative cell voltage based on the monitored cell voltage;
determining a magnitude of the negative cell voltage;
determining an operation time limit based on the determined magnitude;
terminating operation of the fuel cell stack when a negative cell voltage operation time exceeds the determined operation time limit.

10. The method as recited in claim 9, further comprising:
accumulating the negative cell voltage operation time; and
storing the accumulated negative cell voltage operation time in a nonvolatile memory.

11. The method as recited in claim 10, wherein the fuel cell stack includes the nonvolatile memory.

12. The method as recited in 9, further comprising:
preventing further operation of the fuel cell stack when the negative cell voltage operation time exceeds the determined operation time limit.

13. A fuel cell system, comprising:
a fuel cell stack having a plurality of fuel cells;
a cell voltage monitor to monitor a cell voltage of each of the plurality of fuel cells;
a controller to control operation of the fuel cell stack, the controller configured to:
detect presence of a negative cell voltage based on the monitored cell voltages;
operate the fuel cell stack for an amount of time during which the negative cell voltage is present; and
terminate operation of the fuel cell stack when the amount of time exceeds a negative cell voltage time limit.

14. The fuel cell system as recited in claim 13, wherein the controller is configured to:
determine a magnitude of the negative cell voltage; and
determine the negative cell voltage time limit based on the determined magnitude.

15. The fuel cell system as recited in claim 14, wherein the controller is configured to prevent further operation of the fuel cell stack when the amount of time exceeds the negative cell voltage time limit.

16. The fuel cell system as recited in claim 14, further comprising a nonvolatile memory to store the amount of time during which the negative cell voltage is present.

17. The fuel cell system as recited in claim 13, further comprising a user interface, wherein the controller is configured to provide an alarm indication that is detectable via the user interface upon detection of the presence of a negative cell voltage.

18. An article comprising a computer readable storage medium accessible by a processor-based system to store instructions that when executed by the processor-based system cause the processor-based system to:
detect a negative cell voltage condition of a fuel cell stack; and
operate the fuel cell stack for an amount of time during which the negative cell voltage condition is present; and
terminate operation of the fuel cell stack when the amount of time exceeds a first time threshold.

19. The article as recited in claim 18, the storage medium storing instructions that when executed cause the processor-based system to:
monitor a cell voltage of the fuel cell stack;
detect presence of a negative cell voltage based on the monitored cell voltage.

20. The article as recited in claim 19, the storage medium storing instructions that when executed cause the processor-based system to:
determine a magnitude of the negative cell voltage; and
determine the first time threshold based on the determined magnitude.

21. The method as recited in claim 20, further comprising:
prevent further operation of the fuel cell stack when the amount of time exceeds the first time threshold.
